(19) United States
(12) Patent Application Publication
(10) Pub. No.: US 2026/0095109 A1
(43) Pub. Date: Apr. 2, 2026

(54) TRACTION INVERTER MODULE, POWER ELECTRONIC SYSTEM, METHOD FOR FABRICATING A TRACTION INVERTER MODULE AND METHOD FOR CONNECTING A TRACTION INVERTER MODULE TO A DC-LINK CAPACITOR

(71) Applicant: Infineon Technologies AG, Neubiberg (DE)

(72) Inventors: Peter Weiß, Kelheim (DE); Mark Nils Münzer, Neubiberg (DE); Christoph Koch, Salzkotten (DE)

(21) Appl. No.: 19/328,684

(22) Filed: Sep. 15, 2025

(30) Foreign Application Priority Data
Sep. 27, 2024 (DE) 102024209390.4
Aug. 20, 2025 (DE) 102025133357.2

(51) Int. Cl. H02M 7/00; H02M 7/537

(52) U.S. Cl. CPC H02M 7/003; H02M 7/537

(57) ABSTRACT

A traction inverter module includes: a plurality of power semiconductor dies connected together to form an inverter circuit including a half bridge, the inverter circuit being configured to be operated in a 3-level topology mode; an encapsulation encapsulating the power semiconductor dies; a first and a second external contact exposed from the encapsulation and configured as DC+ terminals and DC− terminals of the half bridge, respectively, the first and the second external contact being configured to be screwed and/or welded to a DC link capacitor; and a press-fit pin exposed from the encapsulation and configured as an N terminal of the half bridge.

### TECHNICAL FIELD

The present disclosure relates to a traction inverter module, to a power electronic system comprising a traction inverter module, to a method for fabricating a traction inverter module and to a method for connecting a traction inverter module to a DC-link capacitor.

### BACKGROUND

A traction inverter module may be configured for 2-level topology operation, meaning that the output voltage has two possible levels: a positive and a negative voltage. A traction inverter module may also be configured for 3-level topology operation, meaning that the output voltage has three possible levels: positive, neutral and negative voltage. This allows the output waveform of the traction inverter module to have more steps, creating a closer approximation to a sinusoidal waveform. Compared to 2-level topology operation, using an electric motor with a traction inverter module that operates in 3-level topology may generate reduced harmonic frequencies in the electric motor which in turn increases the overall system efficiency. For example in the case of an electric vehicle, 3-level topology operation may therefore increase the mileage of the vehicle compared to operation in 2-level topology. However, traction inverter modules configured for 3-level topology operation may require comparatively complex DC-link capacitor designs and/or comparatively complex techniques for connecting the traction inverter module to the DC-link capacitor. Improved traction inverter modules, improved power electronic systems, improved methods for fabricating a traction inverter module and improved methods for connecting a traction inverter module to a DC-link capacitor may help with solving these and other problems.

### SUMMARY

Various aspects pertain to a traction inverter module, comprising: a plurality of power semiconductor dies connected together to form an inverter circuit comprising a half bridge, wherein the inverter circuit is configured to be operated in 3-level topology mode, an encapsulation encapsulating the power semiconductor dies, a first and a second external contact exposed from the encapsulation and configured as DC+ terminals and DC− terminals of the half bridge, respectively, wherein the first and second external contacts are configured to be screwed and/or welded to a DC link capacitor, and a press-fit pin exposed from the encapsulation and configured as an N terminal of the half bridge.

Various aspects pertain to a power electronic system, comprising: the traction inverter module of one of the preceding claims, and a DC link capacitor comprising first, second and third connection elements, wherein the first connection element is screwed and/or welded to the first external contact of the traction inverter module, wherein the second connection element is screwed and/or welded to the second external contact of the traction inverter module, and wherein the third connection element is pressed onto the press-fit pin of the traction inverter module.

Various aspects pertain to a method for fabricating a traction inverter module, the method comprising: providing a plurality of power semiconductor dies and electrically connecting the power semiconductor dies together to form an inverter circuit comprising a half bridge, wherein the inverter circuit is configured to be operated in 3-level topology mode, encapsulating the power semiconductor dies with an encapsulation, providing first and second external contacts exposed from the encapsulation and configured as DC+ terminals and DC− terminals of the half bridge, respectively, wherein the first and second external contacts are configured to be screwed and/or welded to a DC link capacitor, and providing a press-fit pin exposed from the encapsulation and configured as an N terminal of the half bridge.

Various aspects pertain to a method for connecting a traction inverter module to a DC link capacitor, the method comprising: providing the traction inverter module of one of examples 1 to 9, providing a DC link capacitor comprising first, second and third connection elements, screwing and/or welding the first connection element to the first external contact of the traction inverter module, screwing and/or welding the second connection element to the second external contact of the traction inverter module, and pressing the third connection element onto the press-fit pin of the traction inverter module.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIGS. 1A and 1B illustrate a traction inverter module configured for 3-level topology operation, wherein an N terminal of the traction inverter module is provided by a press-fit pin of the module. FIG. 1A shows a plan view and FIG. 1B shows a sectional view of the traction inverter module.

FIG. 2 illustrates an exemplary half bridge circuit with for 3-level topology operation which may be incorporated in a traction inverter module.

FIG. 3 illustrates a plan view of a further exemplary traction inverter module configured for 3-level topology operation, wherein the traction inverter module comprises three half bridges.

FIG. 4 illustrates a detail view of an exemplary traction inverter module. FIG. 4 in particular shows first and second external contacts, i.e. the DC+ and DC− terminals, and a press-fit pin, i.e. the N terminal, of the traction inverter module.

FIG. 5 illustrates a power electronic system comprising a traction inverter module connected to a DC-link capacitor.

FIG. 6 is a flow chart of an exemplary method for fabricating a traction inverter module.

FIG. 7 is a flow chart of an exemplary method for connecting a traction inverter module to a DC-link capacitor.

FIGS. 8A and 8B illustrate a further traction inverter module configured for 3-level topology operation, wherein an N terminal of the traction inverter module is provided by a tab. FIG. 8A is a sectional view and FIG. 8B is a plan view of the traction inverter module.

FIGS. 9A and 9B illustrate further power electronic systems comprising the traction inverter module of FIGS. 8A and 8B connected to a DC-link capacitor.

FIG. 10 illustrates a further traction inverter module configured for 3-level topology operation, wherein the traction inverter module comprises a plastic frame.

### DETAILED DESCRIPTION

In the following detailed description, known structures and elements are shown in schematic form in order to facilitate describing one or more aspects of the disclosure. In this regard, directional terminology, such as “top”, “bottom”, “left”, “right”, “upper”, “lower” etc., is used with reference to the orientation of the Figure(s) being described. Because components of the disclosure can be positioned in a number of different orientations, the directional terminology is used for purposes of illustration only. It is to be understood that other examples may be utilized and structural or logical changes may be made.

In addition, while a particular feature or aspect of an example may be disclosed with respect to only one of several implementations, such feature or aspect may be combined with one or more other features or aspects of the other implementations as may be desired and advantageous for any given or particular application, unless specifically noted otherwise or unless technically restricted. Furthermore, to the extent that the terms “include”, “have”, “with” or other variants thereof are used in either the detailed description or the claims, such terms are intended to be inclusive in a manner similar to the term “comprise”. The terms “coupled” and “connected”, along with derivatives thereof may be used. It should be understood that these terms may be used to indicate that two elements cooperate or interact with each other regardless whether they are in direct physical or electrical contact, or they are not in direct contact with each other; intervening elements or layers may be provided between the “bonded”, “attached”, or “connected” elements. However, it is also possible that the “bonded”, “attached”, or “connected” elements are in direct contact with each other. Also, the term “exemplary” is merely meant as an example, rather than the best or optimal.

The power semiconductor dies of the traction inverter modules described below can be manufactured from specific semiconductor material, for example Si, SiC, SiGe, GaAs, GaN, or from any other semiconductor material, and, furthermore, may contain one or more of inorganic and organic materials that are not semiconductors, such as for example insulators, plastics or metals.

In several examples layers or layer stacks may be applied to one another or materials are applied or deposited onto layers. It should be appreciated that any such terms as “applied” or “deposited” are meant to cover literally all kinds and techniques of applying layers onto each other. In particular, they are meant to cover techniques in which layers are applied at once as a whole like, for example, laminating techniques as well as techniques in which layers are deposited in a sequential manner like, for example, sputtering, plating, molding, CVD, etc.

An efficient traction inverter module, an efficient power electronic system, an efficient method for fabricating a traction inverter module and an efficient method for connecting a traction inverter module to a DC-link capacitor may for example reduce material consumption, ohmic losses, chemical waste, etc. and may thus enable energy and/or resource savings. Improved devices and methods, as specified in this description, may thus at least indirectly contribute to green technology solutions, i.e. climate-friendly solutions providing a mitigation of energy and/or resource use.

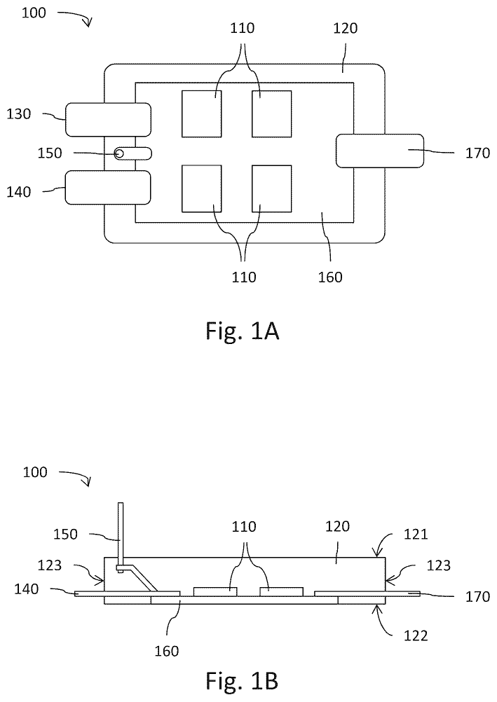

FIGS. 1A and 1B show a traction inverter module 100 comprising a plurality of power semiconductor dies 110, an encapsulation 120, a first external contact 130, a second external contact 140 and a press-fit pin 150. FIG. 1A shows a plan view and FIG. 1B shows a sectional view of the traction inverter module 100. Note that the traction inverter module 100 may comprise further components, e.g. electrical connectors like bond wires or solder joints, not shown in FIGS. 1A and 1B.

The traction inverter module 100 may for example be configured for use in automotive applications. However, according to another example, the traction inverter module 100 is configured for use in household applications or for use in industrial applications.

The power semiconductor dies 110 may for example be connected together to form an inverter circuit comprising a half bridge. According to an example, the traction inverter module 100 comprises a single half bridge. In this case, the traction inverter module 100 may be configured to be connected together with further traction inverter modules 100. For example, three traction inverter modules 100 may be connected together to provide an inverter circuit with three phases. According to another example, the traction inverter module 100 comprises a plurality of half bridges, for example three half bridges. In this case, each of the half bridges may comprise separate power semiconductor dies 110, first and second external contacts 130, 140 and one or more press-fit pins 150.

The inverter circuit of the traction inverter module 100 may be configured to be operated in 3-level topology mode. For this reason, a half bridge of the traction inverter module 100 may comprise a terminal for comparatively high voltage (DC+ terminal), a terminal for a comparatively low voltage (DC− terminal) and a terminal for a voltage between the high voltage and the low voltage (N terminal). Furthermore, the half bridge may comprise a phase current terminal which may e.g. be an output terminal. Compared to 2-level topology mode, 3-level topology mode may cause reduced harmonic frequencies in an electric motor and may improve the system efficiency.

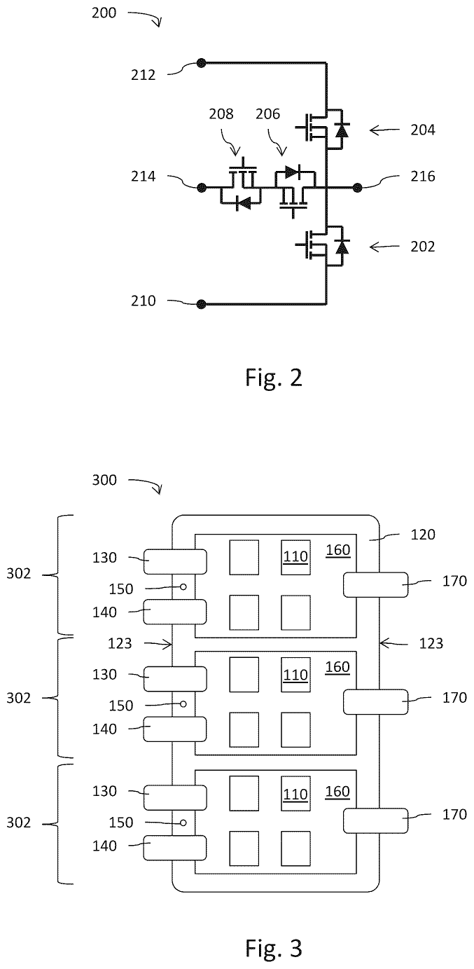

According to an example, a half bridge of the traction inverter module 100 comprises four switches: a high side switch, a low side switch and two further switches arranged at the middle point between high side and low side, compare FIG. 2. Each of the switches may be provided by an individual power semiconductor die 110. However, it is also possible that two or more switches are provided by a common power semiconductor die 110 in a monolithic integration scheme.

The encapsulation 120 encapsulates the power semiconductor dies 110. The encapsulation 120 may in particular be configured to protect the power semiconductor dies 110 from environmental influences. The encapsulation 120 may comprise or consist of any suitable dielectric material. For example, the encapsulation 120 may comprise or consist of a plastic frame enclosing an interior volume and a potting material at least partially filling the interior volume. According to another example, the encapsulation 120 comprises or consists of a molded body. Such a molded body may for example be fabricated by compression molding, injection molding or transfer molding. According to an example, the encapsulation 120 comprises inorganic filler particles configured to reduce the thermal resistance of the encapsulation 120.

The encapsulation 120 may for example comprise a first side 121, an opposite second side 122 and lateral sides 123 connecting the first and second sides 121, 122. The second side 122 may, for example, be configured to be arranged over an external appliance, e.g. a heatsink or a board.

According to an example of the traction inverter module 100, the power semiconductor dies 110 are arranged over and electrically connected to at least one power electronic substrate 160. For example, all power semiconductor dies 110 of a half bridge may be arranged over a common power electronic substrate 160. In this case, the traction inverter module 100 may comprise a power electronic substrate 160 for each half bridge. The power electronic substrate 160 may for example be a substrate of the type direct copper bond (DCB), active metal braze (AMB), insulated metal substrate (IMS), etc. The power semiconductor dies 110 may be arranged over an upper side of the power electronic substrate 160 and may be electrically connected to a metal layer on the upper side, for example via solder joints, sintered joints or joints comprising conductive glue. According to an example, an opposite lower side of the power electronic substrate 160 is exposed from the second side 122 of the encapsulation 120 such that the lower side can be coupled to a heatsink.

The first external contact 130 and the second external contact 140 are exposed from the encapsulation 120. For example, the first and second external contacts 130, 140 may be arranged side by side as viewed from above the first side 121 of the encapsulation 120. The first and second external contacts 130, 140 may be exposed from the same side of the encapsulation 120, for example from the same lateral side 123.

The first and second external contacts 130, 140 may comprise or consist of any suitable metal or metal alloy. For example, the first and second external contacts 130, 140 may comprise or consist of Al or Cu. The first and second external contacts 130, 140 may for example be metal clips and fabricating the traction inverter module 100 may comprise singulating the metal clips from a frame.

The first and second external contacts 130, 140 may be power contacts of the traction inverter module 100, configured to carry a strong current, e.g. a current of 1 A or more, or 10 A or more, or 100 A or more, and/or to have a high voltage applied, e.g. a voltage of 100V or more, or 500V or more, or 1.2 kV or more.

The traction inverter module 100 may comprise one or more additional external contacts, for example one or more power contacts and/or one or more control contacts. According to an example, the traction inverter module 100 comprises a third external contact 170 configured as a phase current contact of the half bridge. The third external contact 170 may for example be exposed from a further one of the lateral sides 123 of the encapsulation, e.g. opposite to the first and second external contacts 130, 140. The third external contact 170 may for example have the same structure as the first and second external contacts 130, 140.

The first external contact 130 is configured as a DC+ terminal of the half bridge and the second external contact 140 is configured as a DC− terminal of the half bridge of the traction inverter module 100. The third external contact 170 may for example be configured as a phase current terminal of the half bridge.

The first and second external contacts 130, 140 are configured to be connected to a DC-link capacitor, for example via welded joints and/or joints comprising screws.

The press-fit pin 150 is exposed from the encapsulation 120. For example, the press-fit pin 150 may be exposed from the first side 121 of the encapsulation 120. The press-fit pin 150 may in particular be arranged at an edge of the first side 121, for example the edge between the first side 121 and the particular lateral side 123 from which the first and second external contacts 130, 140 are exposed. The press-fit pin 150 may for example be arranged between the first and second external contacts 130, 140, as viewed from above the first side 121. The press-fit pin 150 is configured as an N terminal of the half bridge of the traction inverter module 100. The press-fit pin 150 may be configured to be connected to a DC-link capacitor via a press-fit joint.

According to an example, the traction inverter module 100 may comprise one or more additional press-fit pins which are not configured as N terminals of the one or more half bridges. Instead, the additional press-fit pins may be configured as control and/or sensing contacts of the traction inverter module 100. The additional press-fit pins may for example also be exposed from the first side 121 of the encapsulation 120 and may for example be configured to be pressed into an external appliance like a control board.

FIG. 2 shows an exemplary half bridge circuit 200 which may be incorporated in the traction inverter module 100. The half bridge circuit 200 is configured to provide 3-level topology. The exemplary half bridge circuit 200 of FIG. 2 has a T-type configuration but other configurations are also possible.

As shown in FIG. 2, the half bridge circuit 200 comprises a low side switch 202, a high side switch 204 and a third and a fourth switch 206, 208 connected to a point between the low side switch 202 and the high side switch 204. The half bridge circuit 200 further comprises a DC− terminal 210, a DC+ terminal 212, an N terminal 214 and a phase current terminal 216. The switches 202-208 may be provided by the power semiconductor dies 110 and the terminals 210-216 may be provided by the external contacts 130, 140, 170 and the press-fit pin 150.

According to an example, the DC− terminal 210, the DC+ terminal 212 and the N terminal 214 may be configured to be connected to a DC-link capacitor. The phase current terminal 214 may be configured to be connected to an electric engine.

According to an example, the half bridge circuit 200 is configured to be operated in 3-level topology mode or in 2-level topology mode, wherein the operation mode may be switched from one of these modes to the other one of these modes based on requirements like, for example, efficiency or strength of electrical current. Switching between 3-level topology mode and 2-level topology mode may comprise switching on and switching off the third switch 206 and/or the fourth switch 208.

Operation in 3-level topology mode may for example cause less harmonic frequencies in an electric engine connected to the traction inverter module 100 compared to operation in 2-level topology mode. Operation in 3-level topology mode may therefore save battery charge in the case of e.g. an electric vehicle, in particular within the WLTP (worldwide harmonized light vehicles test procedure) driving cycle. On the other hand, 2-level topology mode may for example be used at higher velocities and consequently higher currents flowing through the traction inverter module 100, e.g. while driving on a freeway. In this case, the traction inverter module 100 may be configured to tolerate comparatively higher currents flowing through the inverter circuit in the 2-level topology mode than in the 3-level topology mode. In particular the press-fit pin(s) 150 may be configured to tolerate a comparatively smaller current than the external contacts 130, 140. However, it is also possible that the traction inverter module 100 is configured to tolerate the comparatively high currents in the 3-level topology mode. In this case, the 3-level topology mode may for example also be used while driving at higher velocities. In particular the press-fit pins 150 may in this case have a comparatively large diameter or there may be more than one press-fit pin 150 for each N terminal in order to support higher currents. In this case, it may not be necessary that the traction inverter module 100 is configured to switch between 2-level topology mode and 3-level topology mode but this may still be the case.

FIG. 3 shows a plan view of a further traction inverter module 300 which may be similar or identical to the traction inverter module 100, except for the differences described in the following.

In particular, the traction inverter module 300 comprises three half bridge circuits 302. Each of the three half bridge circuits 302 may comprise the components described with respect to the traction inverter module 100. Each half bridge circuit 302 may in particular comprise a first, a second and a third external contact 130, 140, 170 configured as DC+ terminal, DC− terminal and phase current terminal, respectively, and a press-fit contact 150 configured as an N terminal, as explained above. Each half bridge 302 furthermore may comprise a plurality of power semiconductor dies 110 arranged over a common power electronic substrate 160.

As shown in FIG. 3, the half bridge circuits 302 may for example be arranged side by side in the encapsulation 120 such that all of the first and second external contacts 130, 140 are arranged at a first one of the lateral sides 123 of the encapsulation 120. The third external contacts 170 may be arranged at a second, opposite one of the lateral sides 123. The press-fit pins 150 of the half bridge circuits 302 may for example all be arranged at an edge of the encapsulation 120, close to the first one of the lateral sides 123, compare FIG. 3.

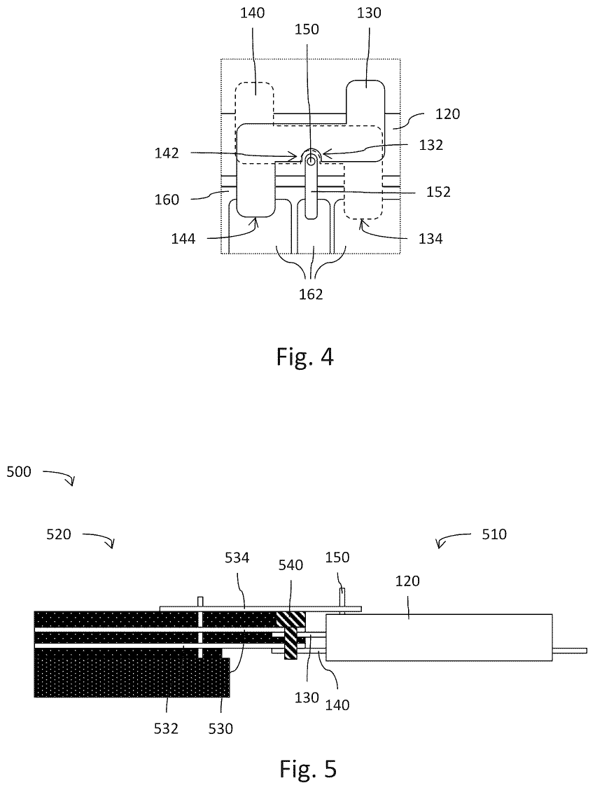

FIG. 4 shows a detail view of the traction inverter module 100 or 300 from above the first side 121, according to a specific example. FIG. 4 in particular shows the first and second external contacts 130, 140 and the press-fit pin 150. In FIG. 4, the first external contact 130 is drawn using solid lines and the second external contact 140 is drawn using dashed lines in order to make the first and second external contacts 130, 140 more easily distinguishable.

In the example shown in FIG. 4, the first and second external contacts 130 and 140 partially overlap as viewed from above the traction inverter module 100 or 300. This overlap may for example reduce inductances and may therefore improve the electrical characteristics of the traction inverter module.

In the example shown in FIG. 4, the press-fit pin 150 is arranged within overlapping recesses 132, 142 of the first and second external contacts 130, 140. However, it is also possible that the press-fit pin 150 is arranged within a recess of only one of the external contacts 130, 140 but not the other one of the external contacts 130, 140 because the other one of the external contacts 130, 140 is spaced apart from the press-fit pin 150.

FIG. 4 also shows part of the power electronic substrate 160 according to an example. Internal ends 134, 144 of the first and second external contacts 130, 140 extend to points inside a circumference of the power electronic substrate 160, as viewed from above the power electronic substrate 160. The internal ends 134, 144 may for example be soldered, sintered or glued with conductive glue to the power electronic substrate 160, in particular to conductive traces 162 of the power electronic substrate.

According to the example shown in FIG. 4, the press-fit pin 150 is electrically connected to the power electronic substrate 160 via a contact clip 152. The contact clip 152 may for example be soldered, sintered or glued with conductive glue to a conductive trace 162 of the power electronic substrate. The external contacts 130, 140 and the contact clip 152 may in particular be coupled to the power electronic substrate 160 using the same joining technique. The contact clip 152 may be joined to the press-fit pin 150 by pressing the contact clip 152 onto the press-fit pin 150.

The contact clip 152 may comprise or consist of any suitable metal or metal alloy and may for example comprise or consist of the same material as the external contacts 130, 140. The external contacts 130, 140 and the contact clip 152 may have the same thickness (measured perpendicular to the upper sides of the external contacts 130, 140 and the contact clip 152 shown in FIG. 4). According to an example, an electrical connector like a bond wire or a ribbon instead of the contact clip 152 is used to electrically connect the press-fit pin 150 to the power electronic substrate 160.

According to the example shown in FIG. 4, the press-fit pin 150 is arranged outside a circumference of the power electronic substrate 160 as viewed from above the traction inverter module. A foot part of the press-fit pin 150 may, for example, be arranged within a recess of the encapsulation 120 and may be mechanically fixed to the encapsulation 120. According to an example, additional press-fit pins, e.g. press-fit pins configured as sensing or control contacts, may be arranged over the power electronic substrate 160, that is within the circumference of the power electronic substrate 160.

FIG. 5 shows a power electronic system 500 comprising a traction inverter module 510 and a DC-link capacitor 520. The traction inverter module 510 may be similar or identical to the traction inverter module 100 or 300.

The power electronic system 500 further comprises a first connection element 530, a second connection element 532 and a third connection element 534. The first connection element 530 is screwed (using a screw 540) and/or welded to the first external contact 130 of the traction inverter module 510, the second connection element 532 is screwed (using a screw 540) and/or welded to the second external contact 140 of the traction inverter module 510 and the third connection element 534 is pressed onto the press-fit pin 150 of the traction inverter module 510. In this way, electrical connections between the DC+ terminal, the DC− terminal and the N terminal and the DC-link capacitor are provided. Forming joints by using a screwing process, a welding process or a process comprising a press-fit joint may be comparatively technically simple and/or fast and/or comparatively cheap to manufacture. Furthermore, these joining techniques may produce reliable joints.

According to an example, the first, second and third connection elements 530, 532, 534 comprise or consist of metal clips. According to the example shown in FIG. 5, the first, second and third connection elements 530, 532, 534 are stacked on top of each other. According to an example, the third connection element 534 is pressed onto the press-fit pin 150 prior to screwing and/or welding the first and second connection elements 530, 532 to the first and second external contacts 130, 140. In this case, the connection provided by the third connection element 534 and the press-fit pin 150 may be used to align the traction inverter module 510 and the DC-link capacitor 520 for the screwing and/or welding process. In this case, the external contact elements 130, 140 and the connection elements 530, 532, 534 may be shaped such that the screws 540 can be inserted from above the third connection element 534 and/or such that welding from above is possible. According to another example, the first and second connection elements 530, 532 are welded to the first and second external contacts 130, 140 prior to pressing the third connection element 534 onto the press-fit pin 150.

According to on example, the third connection element 534 has a smaller extension along the y-axis than the first and second connection elements 530, 532 (in other words, the third connection element 534 may be thinner than the first and second connection elements 530, 532 as viewed from above the power electronic system 500). Such a comparatively thin third connection element 534 may facilitate screwing and/or welding the first and second connection elements 530, 532 to the first and second external contacts 130, 140. According to another example, the third connection element 534 may have a similar extension along the y-axis as the first and second connection elements 530, 532. This may ensure low inductivity in the commutation loop.

As shown in FIG. 5, distal ends of the first and second connection elements 530, 532 face the traction inverter module 510 and are arranged outside a circumference of the traction inverter module 510 (more particularly, outside a circumference of the encapsulation 120 of the traction inverter module 510), as viewed from above the power electronic system 500. A distal end of the third connection element 534 on the other hand is arranged within the circumference of the traction inverter module 510 in order to be pressed onto the press-fit pin 150.

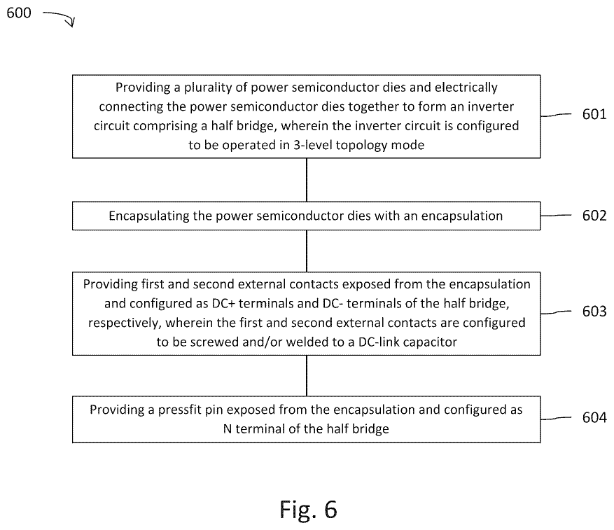

FIG. 6 is a flow chart of an exemplary method 600 for fabricating a traction inverter module. The method 600 may for example be used to fabricate the traction inverter modules 100, 300 and 510.

The method 600 comprises at 601 a process of providing a plurality of power semiconductor dies and electrically connecting the power semiconductor dies together to form an inverter circuit comprising a half bridge, wherein the inverter circuit is configured to be operated in 3-level topology mode; at 602 a process of encapsulating the power semiconductor dies with an encapsulation; at 603 a process of providing first and second external contacts exposed from the encapsulation and configured as DC+ terminals and DC− terminals of the half bridge, respectively, wherein the first and second external contacts are configured to be screwed and/or welded to a DC link capacitor; and at 604 a process of providing a press-fit pin exposed from the encapsulation and configured as an N terminal of the half bridge.

According to an example, the method 600 further comprises a process of arranging the power semiconductor dies over one or more power electronic substrates, wherein the press-fit pin is arranged outside a circumference of the one or more power electronic substrates, as viewed from above the one or more power electronic substrates; and a process of connecting the one or more power electronic substrates to the press-fit pin using a contact clip.

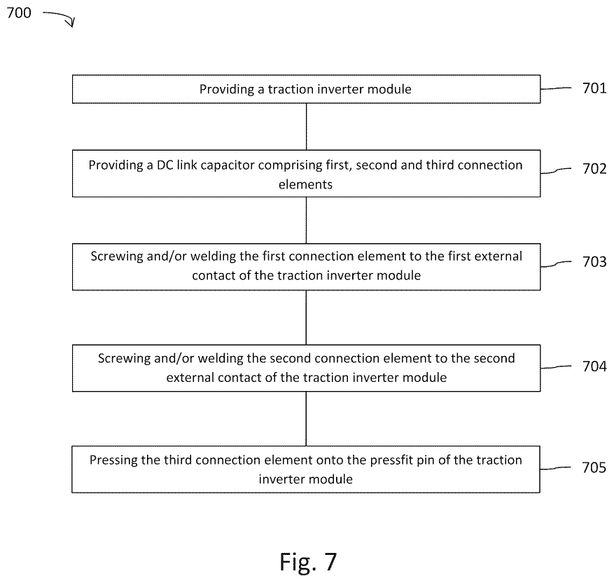

FIG. 7 is a flow chart of an exemplary method 700 for connecting a traction inverter module to a DC-link capacitor. The method 700 may for example be used to connect the traction inverter module 100, 300 or 510 to the DC-link capacitor 520.

The method 700 comprises at 701 a process of providing a traction inverter module; at 702 a process of providing a DC link capacitor comprising first, second and third connection elements; at 703 a process of screwing and/or welding the first connection element to the first external contact of the traction inverter module; at 704 a process of screwing and/or welding the second connection element to the second external contact of the traction inverter module; and at 705 a process of pressing the third connection element onto the press-fit pin of the traction inverter module.

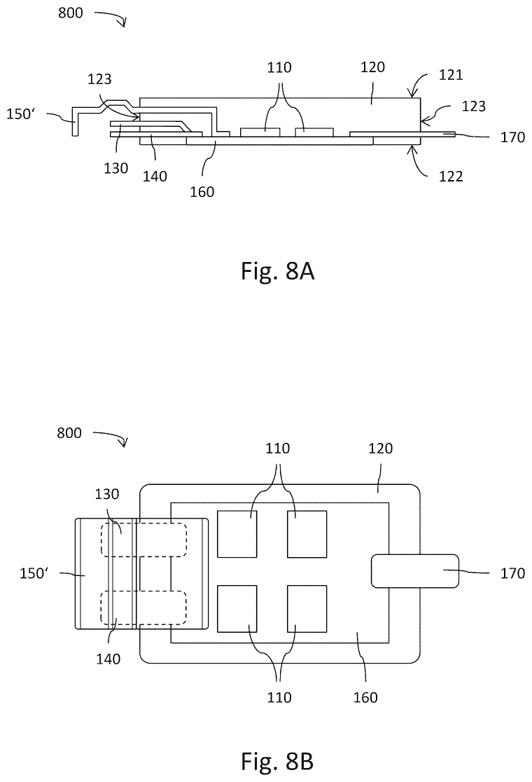

According to an example of the method 700, the third connection element is pressed onto the press-fit pin prior to screwing and/or welding the first and second connection elements to the first and second external contacts. In this case the press-fit pin may be used for correctly aligning the DC link capacitor for the screwing and/or welding process. According to another example, the third connection element is provided and pressed onto the press-fit pin after the first and second connection elements have been screwed and/or welded to the first and second external contacts. FIGS. 8A and 8B show a further traction inverter module 800, which may be similar or identical to any of the traction inverter modules 100 to 510, except for the differences described in the following. FIG. 8A shows a sectional view and FIG. 8B shows a plan view of the traction inverter module 800.

In particular, in the traction inverter module 800, the press-fit pin 150 of the traction inverter modules 100 to 510 is replaced by a further external contact 150′. The further external contact 150′ comprises or consists of a tab, in particular a metal tab. For example, the first and second external contacts 130, 140 and the further external contact 150′ may essentially be similar tabs and may comprise or consist of the same metal or metal alloy. The tabs may for example comprise a flat surface as viewed from above the first side 121 of the encapsulation 120. The further external contact 150′ may be coupled to the power electronic substrate 160 in a similar manner as the first and second external contacts 130, 140. Analogous to the press-fit pin 150, the further external contact 150′ is exposed from the encapsulation 120 and the further external contact 150′ is configured as an N terminal of the half bridge circuit of the traction inverter module 800.

As shown in FIGS. 8A and 8B, the further external contact 150′ is arranged vertically above the first and second external contacts 130, 140. The further external contact 150′ may for example completely or almost completely overlap the first and/or the second external contact 130, 140, as viewed from above the first side 121 of the encapsulation 120 (compare FIG. 8B). The first and second external contacts 130, 140 may also at least partially overlap each other, as for example explained with respect to FIG. 4. Such an overlap of the external contacts 130, 140 and 150′ may reduce inductances in the traction inverter module 800. Note that in FIG. 8B the first and second external contacts 130, 140 are drawn using dashed lines to indicate that the first and second external contacts 130, 140 are overlapped by the further external contact 150′.

According to the specific example of the traction inverter module 800 shown in FIGS. 8A and 8B, the first external contact 130, the second external contact 140 and the further external contact 150′ are all exposed from the same one of the lateral sides 123 of the encapsulation 120. Furthermore, a distal end of the further external contact 150′ may be arranged further away from the lateral side 123 than distal ends of the first and second external contacts 130, 140.

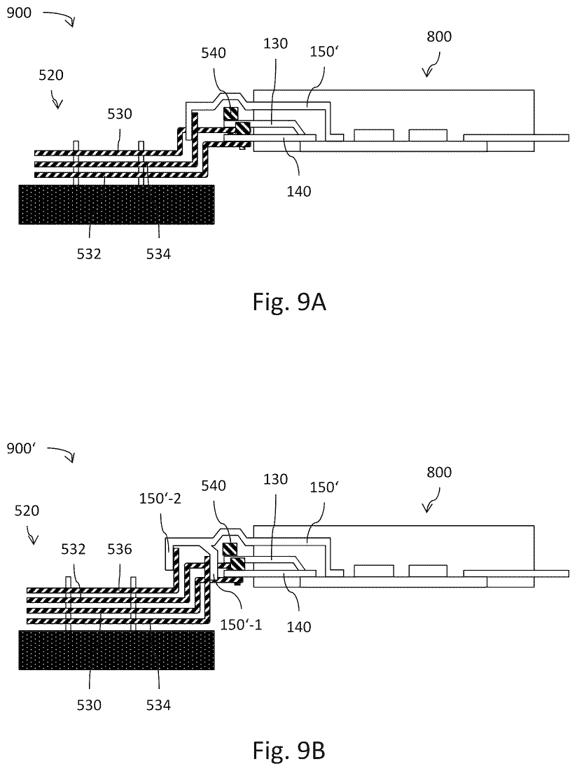

FIGS. 9A and 9B show further power electronic systems 900 and 900′, respectively, which may be similar or identical to the power electronic system 500, except for the differences described in the following.

As shown in FIG. 9A, the power electronic system 900 comprises the traction inverter module 800 and the DC-link capacitor 520. The DC-link capacitor 520 comprises first, second and third connection elements 530, 532, 534, wherein the first external contact 130 is connected to the first connection element 530, the second external contact 140 is connected to the second connection element 532 and the further external contact 150′ is connected to the third connection element 534. An electrically insulating material (not shown in FIGS. 9A and 9B) may be arranged between the connection elements 530, 532, 534 (and possibly also between the external contacts 130, 140, 150′).

According to an example, the first connection element 530 is connected to the first external connector 130 using a screw 540. Additionally or alternatively, a welding connection may be used. The second connection element 532 may be connected to the second external contact 140 in the same manner. Furthermore, the third connection element 534 may be connected to the further external contact 150′ in the same manner. However, it is also possible that the further external contact 150′ is pressed or clamped onto the third connection element 534.

As shown in FIG. 9A, the further external contact 150′ at least partially overlaps the first and second external contacts 130, 140 as well as the first and second connection elements 530, 532.

As shown in FIG. 9A, the third connection element 534 may for example be arranged between the first and second connection elements 530, 532. This arrangement may exhibit reduced inductance compared to an arrangement of the third connection element 534 above or below both the first and second connection elements 530, 532.

In the power electronic system 900′ shown in FIG. 9B, the DC-link capacitor 520 further comprises a fourth connection element 536, wherein the further external contact 150′ is also connected to the fourth connection element 536. For example, the further external contact may comprise a first connection portion 150′-1 connected to the third connection element 534 and a second connection portion 150′-2 connected to the fourth connection element 536. The first and second connection portions 150′-1, 150′-2 may essentially form a clamp clamping the third and fourth connection elements 534, 536.

Furthermore, the first and second connection elements 530, 532 are at least partially arranged between the third and fourth connection elements 534, 536. This stacked configuration of the connection elements 530-536 may for example exhibit a reduced inductance. The inductance may in particular be lower compared to the power electronic system 900 of FIG. 9A.

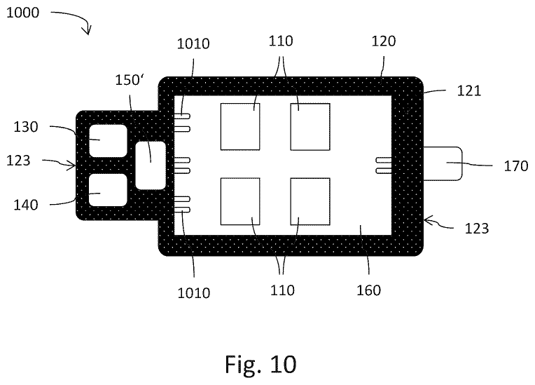

FIG. 10 shows a further traction inverter module 1000, which may be similar or identical to the traction inverter module 800, except for the differences described in the following.

In the traction inverter module 1000, the encapsulation 120 comprises or consists of a plastic frame, in particular a hard plastic frame. Furthermore, at least the further external contact 150′ is arranged within a circumference of the plastic frame, as viewed from above the first side 121 of the encapsulation 120. Note that in the particular example of the traction inverter module 1000 shown in FIG. 10, the first and second external contacts 130, 140 as well are arranged within the circumference of the encapsulation 120. The third external contact 170 on the other hand is at least partially arranged outside of the circumference of the encapsulation 120.

According to an example, the first and second external contacts 130, 140 and the further external contact 150′ are configured to be connected to a DC-link capacitor by welding from above the first side 121 of the encapsulation 120, but not by screwing.

Internal ends of the external contacts 130, 140, 150′ and 170 may comprise connection portions 1010 coupled, e.g. soldered, to the power electronic substrate 160. The encapsulation 120 may for example comprise a lower plastic part and an upper plastic part. Fabricating the traction inverter module 1000 may comprise providing the lower plastic part, arranging the external contacts 130, 140, 150′ and 170 over the lower plastic part, providing the upper plastic part and combining the lower and upper plastic parts (e.g. by plugging the parts together) and thereby clamping the external contacts 130, 140, 150′ and 170 between the upper and lower parts.

According to the specific example of the traction inverter module 1000 shown in FIG. 10, a portion of the further external contact 150′ that is exposed from the plastic frame is arranged closer to a center of the power electronic substrate 160 than exposed portions of the first and second external contacts 130, 140. However, it is for example also possible that the exposed portions of the first, second and further external contacts 130, 140 and 150′ are arranged side by side along the same lateral side 123 of the encapsulation 120.

In the following, the traction inverter module, the power electronic system, the method for fabricating a traction inverter module and the method for connecting a traction inverter module to a DC link capacitor are further explained using specific examples.

Example 1 is a traction inverter module, comprising: a plurality of power semiconductor dies connected together to form an inverter circuit comprising a half bridge, wherein the inverter circuit is configured to be operated in 3-level topology mode, an encapsulation encapsulating the power semiconductor dies, a first and a second external contact exposed from the encapsulation and configured as DC+ terminals and DC− terminals of the half bridge, respectively, wherein the first and second external contacts are configured to be screwed and/or welded to a DC link capacitor, and a press-fit pin exposed from the encapsulation and configured as an N terminal of the half bridge.

Example 2 is the traction inverter module of example 1, wherein the inverter circuit is configured to be switched from operation in the 3-level topology mode to operation in 2-level topology mode and back.

Example 3 is the traction inverter module of example 2, wherein the traction inverter module is configured to tolerate comparatively higher currents flowing through the inverter circuit in the 2-level topology mode than in the 3-level topology mode.

Example 4 is the traction inverter module of example 2, wherein the traction inverter module is configured to tolerate currents of equal strength flowing through the inverter circuit in the 2-level topology mode and in the 3-level topology mode.

Example 5 is the traction inverter module of one of the preceding examples, wherein the inverter circuit comprising three half bridges.

Example 6 is the traction inverter module of one of the preceding examples, wherein the first external contact at least partially overlaps the second external contact.

Example 7 is the traction inverter module of one of the preceding examples, wherein the encapsulation comprises a first side, an opposing second side and lateral sides connecting the first and second sides, and wherein the first and the second external contact are exposed from one of the lateral sides of the encapsulation and the press-fit pin is exposed from the first side of the encapsulation.

Example 8 is the traction inverter module of example 7, wherein the press-fit pin is arranged within recesses of the first and/or second external contact.

Example 9 is the traction inverter module of example 7 or 8, wherein the traction inverter module comprises at least one power electronic substrate, wherein the power semiconductor dies are arranged on the at least one power electronic substrate, and wherein the press-fit pin is arranged outside a circumference of the at least one power electronic substrate, as viewed from above the at least one power electronic substrate.

Example 10 is a power electronic system, comprising: the traction inverter module of one of the preceding claims, and a DC link capacitor comprising first, second and third connection elements, wherein the first connection element is screwed and/or welded to the first external contact of the traction inverter module, wherein the second connection element is screwed and/or welded to the second external contact of the traction inverter module, and wherein the third connection element is pressed onto the press-fit pin of the traction inverter module.

Example 11 is the power electronic system of example 10, wherein the first, second and third connection elements are stacked on top of each other.

Example 12 is the power electronic system of example 10 or 11, wherein distal ends of the first and second connection elements face the traction inverter module and are arranged outside a circumference of the traction inverter module and wherein a distal end of the third connection element is arranged within the circumference, as viewed from above the power electronic system.

Example 13 is a method for fabricating a traction inverter module, the method comprising: providing a plurality of power semiconductor dies and electrically connecting the power semiconductor dies together to form an inverter circuit comprising a half bridge, wherein the inverter circuit is configured to be operated in 3-level topology mode, encapsulating the power semiconductor dies with an encapsulation, providing first and second external contacts exposed from the encapsulation and configured as DC+ terminals and DC− terminals of the half bridge, respectively, wherein the first and second external contacts are configured to be screwed and/or welded to a DC link capacitor, and providing a press-fit pin exposed from the encapsulation and configured as an N terminal of the half bridge.

Example 14 is the method of example 13, further comprising: arranging the power semiconductor dies over one or more power electronic substrates, wherein the press-fit pin is arranged outside a circumference of the one or more power electronic substrates, as viewed from above the one or more power electronic substrates, and connecting the one or more power electronic substrates to the press-fit pin using a contact clip.

Example 15 is a method for connecting a traction inverter module to a DC link capacitor, the method comprising: providing the traction inverter module of one of examples 1 to 9, providing a DC link capacitor comprising first, second and third connection elements, screwing and/or welding the first connection element to the first external contact of the traction inverter module, screwing and/or welding the second connection element to the second external contact of the traction inverter module, and pressing the third connection element onto the press-fit pin of the traction inverter module.

Example 16 is the method of example 15, wherein the third connection element is pressed onto the press-fit pin prior to screwing and/or welding the first and second connection elements to the first and second external contacts, and wherein the press-fit pin is used for correctly aligning the DC link capacitor for the screwing and/or welding process.

Example 17 is a traction inverter module, comprising: a plurality of power semiconductor dies connected together to form an inverter circuit comprising a half bridge, wherein the inverter circuit is configured to be operated in 3-level topology mode, an encapsulation encapsulating the power semiconductor dies, a first and a second external contact exposed from the encapsulation and configured as DC+ terminals and DC− terminals of the half bridge, respectively, wherein the first and second external contacts are configured to be screwed and/or welded to a DC link capacitor, and a further external contact exposed from the encapsulation and configured as an N terminal of the half bridge, wherein the further external contact is a tab arranged vertically above the first and second external contacts.

Example 18 is the traction inverter module of example 17, wherein the first external contact, the second external contact and the further external contact are exposed from a same lateral side of the encapsulation, and wherein a distal end of the further external contact is arranged further away from the lateral side than distal ends of the first and second external contacts.

Example 19 is the traction inverter module of example 17, wherein the encapsulation comprises or consists of a plastic frame, and wherein at least the further external contact is arranged within a circumference of the plastic frame, as viewed from above a power electronic substrate of the traction inverter module.

Example 20 is the traction inverter module of example 19, wherein a portion of the further external contact that is exposed from the plastic frame is arranged closer to a center of the power electronic substrate, as viewed from above a power electronic substrate, than portions of the first and second external contacts that are exposed from the plastic frame.

Example 21 is a power electronic system, comprising: the traction inverter module of example 17 or 18, and a DC-link capacitor comprising first, second and third connection elements, wherein the first external contact of the traction inverter module is screwed and/or welded to the first connection element, wherein the second external contact of the traction inverter module is screwed and/or welded to the second connection element, and wherein the further external contact of the traction inverter module is screwed and/or welded and/or pressed or clamped onto the third connection element, and wherein the further external contact at least partially overlaps the first and second external contacts and the first and second connection elements. Example 22 is the power electronic system of example 21, wherein the DC-link capacitor further comprises a fourth connection element, wherein the further external contact is also screwed and/or welded and/or pressed or clamped onto the fourth connection element, and wherein the first and second connection elements are at least partially arranged between the third and fourth connection elements. Example 23 is an apparatus comprising: a controller and a memory coupled to the controller, the memory for storing instructions for the controller, the instructions for performing the method according to anyone of examples 13 to 16.

Example 24 is a computer-readable storage medium embodying instructions for performing a method for fabricating a traction inverter module or a method for connecting a traction inverter module to a DC link capacitor, wherein the instructions, when executed by a controller, cause the controller to perform the method according to anyone of examples 13 to 16.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A traction inverter module, comprising:
a plurality of power semiconductor dies connected together to form an inverter circuit comprising a half bridge, wherein the inverter circuit is configured to be operated in a 3-level topology mode;
an encapsulation encapsulating the power semiconductor dies;
a first and a second external contact exposed from the encapsulation and configured as DC+ terminals and DC− terminals of the half bridge, respectively, wherein the first and the second external contact are configured to be screwed and/or welded to a DC link capacitor; and
a press-fit pin exposed from the encapsulation and configured as an N terminal of the half bridge.

2. The traction inverter module of claim 1, wherein the inverter circuit is configured to be switched from operation in the 3-level topology mode to operation in a 2-level topology mode and back.

3. The traction inverter module of claim 2, wherein the traction inverter module is configured to tolerate comparatively higher currents flowing through the inverter circuit in the 2-level topology mode than in the 3-level topology mode.

4. The traction inverter module of claim 2, wherein the traction inverter module is configured to tolerate currents of equal strength flowing through the inverter circuit in the 2-level topology mode and in the 3-level topology mode.

5. The traction inverter module of claim 1, wherein the inverter circuit comprises three half bridges.

6. The traction inverter module of claim 1, wherein the first external contact at least partially overlaps the second external contact.

7. The traction inverter module of claim 1, wherein the encapsulation comprises a first side, an opposing second side, and lateral sides connecting the first and second sides, and wherein the first and the second external contact are exposed from one of the lateral sides of the encapsulation and the press-fit pin is exposed from the first side of the encapsulation.

8. The traction inverter module of claim 7, wherein the press-fit pin is arranged within a recess of the first and/or second external contact.

9. The traction inverter module of claim 7, further comprising at least one power electronic substrate, wherein the power semiconductor dies are arranged on the at least one power electronic substrate, and wherein the press-fit pin is arranged outside a circumference of the at least one power electronic substrate, as viewed from above the at least one power electronic substrate.

10. A power electronic system, comprising:
the traction inverter module of claim 1, and
the DC-link capacitor,
wherein the DC-link capacitor comprises first, second and third connection elements,
wherein the first connection element of the DC link capacitor is screwed and/or welded to the first external contact of the traction inverter module,
wherein the second connection element of the DC link capacitor is screwed and/or welded to the second external contact of the traction inverter module, and
wherein the third connection element of the DC link capacitor is pressed onto the press-fit pin of the traction inverter module.

11. The power electronic system of claim 10, wherein the first, second and third connection elements are stacked on top of each other.

12. The power electronic system of claim 10, wherein a distal end of the first and the second connection element face the traction inverter module and are arranged outside a circumference of the traction inverter module, and wherein a distal end of the third connection element is arranged within the circumference, as viewed from above the power electronic system.

13. A method for fabricating a traction inverter module, the method comprising:
providing a plurality of power semiconductor dies and electrically connecting the power semiconductor dies together to form an inverter circuit comprising a half bridge, wherein the inverter circuit is configured to be operated in a 3-level topology mode;
encapsulating the power semiconductor dies with an encapsulation;
providing a first and a second external contact exposed from the encapsulation and configured as DC+ terminals and DC− terminals of the half bridge, respectively, wherein the first and the second external contact are configured to be screwed and/or welded to a DC link capacitor; and
providing a press-fit pin exposed from the encapsulation and configured as an N terminal of the half bridge.

14. The method of claim 13, further comprising:
arranging the power semiconductor dies over one or more power electronic substrates, wherein the press-fit pin is arranged outside a circumference of the one or more power electronic substrates, as viewed from above the one or more power electronic substrates; and
connecting the one or more power electronic substrates to the press-fit pin using a contact clip.

15. A method for connecting a traction inverter module to a DC-link capacitor, the method comprising:
providing a traction inverter module that includes a plurality of power semiconductor dies connected together to form an inverter circuit comprising a half bridge, wherein the inverter circuit is configured to be operated in a 3-level topology mode, an encapsulation encapsulating the power semiconductor dies, a first and a second external contact exposed from the encapsulation and configured as DC+ terminals and DC− terminals of the half bridge, respectively, wherein the first and the second external contact are configured to be screwed and/or welded to a DC link capacitor, and a press-fit pin exposed from the encapsulation and configured as an N terminal of the half bridge;
providing a DC link capacitor comprising first, second and third connection elements;
screwing and/or welding the first connection element of the DC link capacitor to the first external contact of the traction inverter module;
screwing and/or welding the second connection element of the DC link capacitor to the second external contact of the traction inverter module; and
pressing the third connection element of the DC link capacitor onto the press-fit pin of the traction inverter module.

16. The method of claim 15, wherein the third connection element is pressed onto the press-fit pin prior to screwing and/or welding the first and the second connection element to the first and the second external contact, respectively, and wherein the press-fit pin aids in aligning the DC-link capacitor for the screwing and/or welding process.

17. A traction inverter module, comprising:
a plurality of power semiconductor dies connected together to form an inverter circuit comprising a half bridge, wherein the inverter circuit is configured to be operated in a 3-level topology mode;
an encapsulation encapsulating the power semiconductor dies;
a first and a second external contact exposed from the encapsulation and configured as DC+ terminals and DC− terminals of the half bridge, respectively, wherein the first and the second external contact are configured to be screwed and/or welded to a DC link capacitor; and
a further external contact exposed from the encapsulation and configured as an N terminal of the half bridge, wherein the further external contact is a tab arranged vertically above the first and the second external contact.

18. The traction inverter module of claim 17, wherein the first external contact, the second external contact and the further external contact are exposed from a same lateral side of the encapsulation, and wherein a distal end of the further external contact is arranged further away from the lateral side than a distal end of the first and the second external contact.

19. The traction inverter module of claim 17, wherein the encapsulation comprises a plastic frame, and wherein at least the further external contact is arranged within a circumference of the plastic frame, as viewed from above a power electronic substrate of the traction inverter module.

20. The traction inverter module of claim 19, wherein a portion of the further external contact that is exposed from the plastic frame is arranged closer to a center of the power electronic substrate, as viewed from above a power electronic substrate, than portions of the first and the second external contact that are exposed from the plastic frame.

21. A power electronic system, comprising:
the traction inverter module of claim 17; and
a DC-link capacitor comprising first, second and third connection elements,
wherein the first external contact of the traction inverter module is screwed and/or welded to the first connection element of the DC-link capacitor,
wherein the second external contact of the traction inverter module is screwed and/or welded to the second connection element of the DC-link capacitor,
wherein the further external contact of the traction inverter module is screwed and/or welded and/or pressed or clamped onto the third connection element of the DC-link capacitor, and
wherein the further external contact at least partially overlaps the first and the second external contact and the first and the second connection element.

22. The power electronic system of claim 21, wherein the DC-link capacitor further comprises a fourth connection element, wherein the further external contact is also screwed and/or welded and/or pressed or clamped onto the fourth connection element, and wherein the first and the second connection element are at least partially arranged between the third and the fourth connection element.
